(19) United States
(12) Patent Application Publication
(10) Pub. No.: US 2009/0199473 A1
(43) Pub. Date: Aug. 13, 2009

(54) Horticultural Growth Medium

(76) Inventors: William J. Watson, JR., Rome, OH (US); Allan Huberman, Saugus, MA (US)

Correspondence Address: WHITE & FUDALA, 57 BEDFORD STREET, SUITE 103, LEXINGTON, MA, 02420, US

(21) Appl. No.: 12/030,572

(22) Filed: Feb. 13, 2008

(51) Int. Cl. A01G 9/02; C05F 11/08

(52) U.S. Cl. 47/65.7; 71/6

(57) ABSTRACT

A horticultural growing medium is made up of composted bark, a carbon-based fibrous material, a hydrophilic polymer, sea solid, and beneficial bacteria/fungicide. The materials are formed into a solid substrate having structural stability, with both micro and macro interconnecting pores. The addition of a controlled release fertilizer provides for a perfect combination of nutrients, water retention, and pest and fungus control.

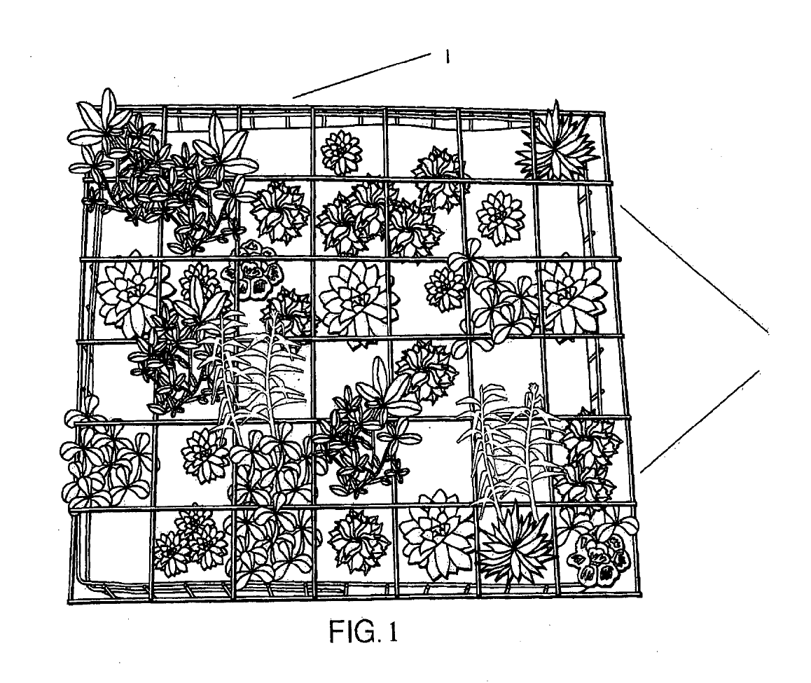

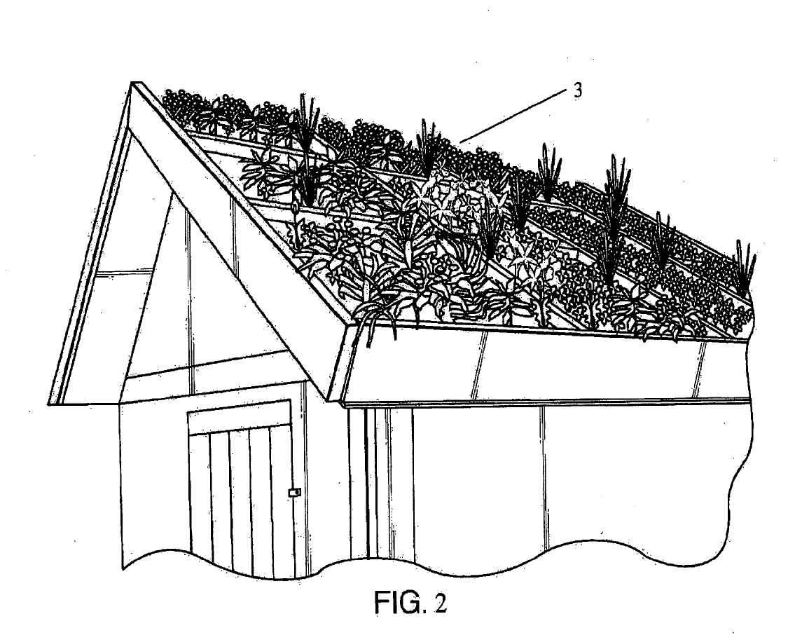

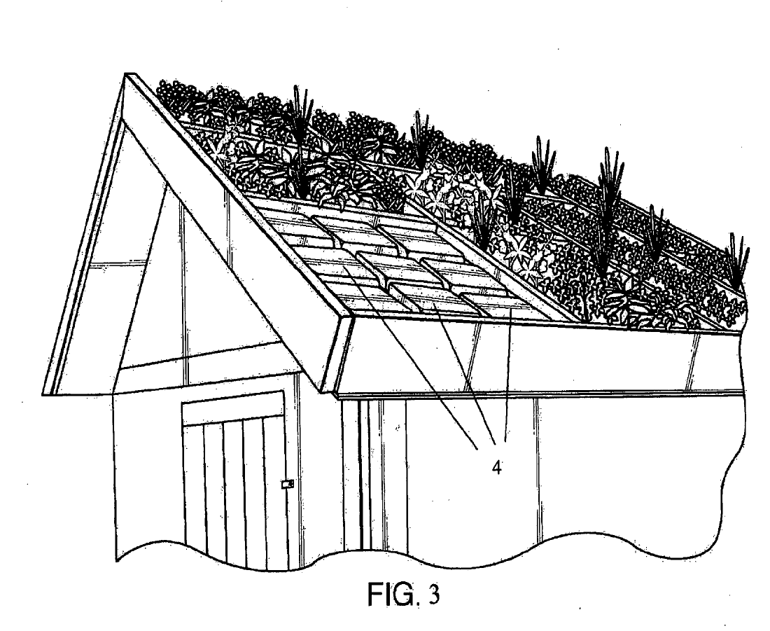

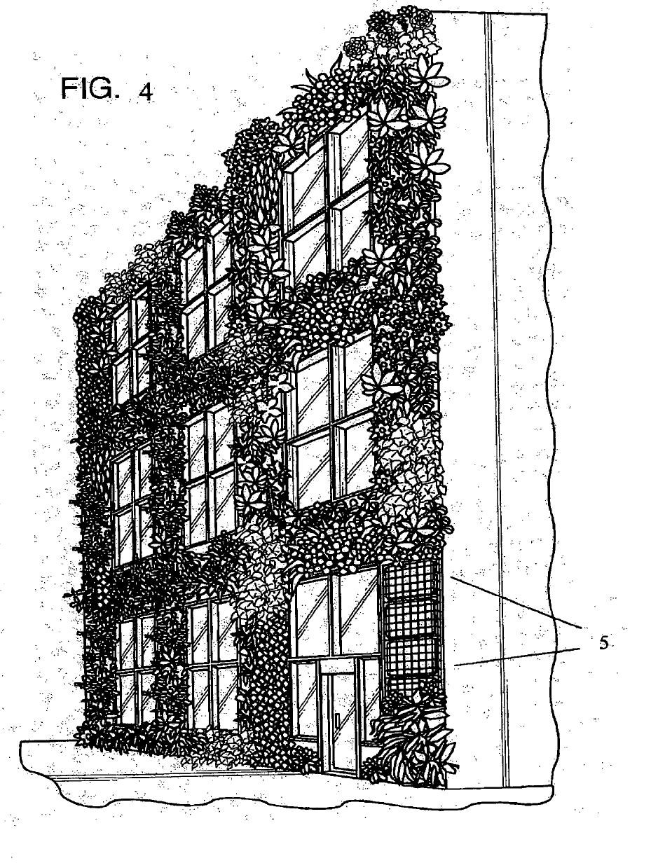

### DESCRIPTION RELATIVE TO THE PRIOR ART

Plant growing media, as substitutes for soil and enhancers of soil, are well known in the prior art. An example is U.S. Pat. No. 6,711,850 (Yelanich) which describes the treating of a plant growing medium to promote improved wetting. Yelanich describes a mixture of coconut coir pith and a horticulturally acceptable surfactant. U.S. Pat. No. 5,451,242 describes an active synthetic soil for horticultural application having all the agro-nutrients essential for plant growth. Mulches are commonly used for retention of water in the prior art. And substrates to provide physical support for plants are also widely known in the prior art. An example of the latter invention is U.S. Pat. No. 6,219,968 (Belger), which describes and claims a solid body for growing plants, having a compact structure, and made of coco peat (coir) having an insertion area for plants on its top side.

The present invention combines all of these elements, in a stable, structured substrate medium with other, additional features which make the invention truly unique.

In the present invention a growing medium is described which provides a means for retaining moisture, and also contains controlled-growth fertilizer to nourish plants. It further contains beneficial bacteria, and most of the mineral elements required for optimum nourishment. Finally, the medium is generally formed into a porous substrate which contains both micro and macro pores, to promote both oxygen and water vapor retention.

Thus the present invention provides all of the components needed for optimal plant growth, and further supplies structural support, in configurations which are virtually unlimited. The material can be ground up and added to soil, or used in place of soil, in containers, such as flower pots. And in addition to the traditional applications this invention is ideal for use in such emerging applications as green walls, green roofs, interior and exterior landscape applications and the like.

Green roofs are contained green spaces on top of human-made structures. Green walls or “vertical gardens, are similar to green roofs, but are vertically oriented on the sides of buildings or other structures, rather than horizontally affixed to the roofs of buildings. A green roof is typically an extension of the existing roof which incorporates a growing medium supporting plants growing on either areas of the roof, or over the entire roof. Reliable water proofing is generally required, and a drainage system is also part of the typical prior art green roof systems. Such systems are described in U.S. Pat. Nos 7,204,057, 6,862,842, and 3 6,711,851.

In contrast to the prior art, the present invention provides a structured medium sufficiently robust so that it may be installed to provide green roofs and green walls without the extensive supporting structures previously required. This material can be configured into shape desired. One advantage in the use of this material is that it can be made modular and of various thickness. The growing medium has great water retention, keeping the growing plants moist for extended periods of time.

Finally, the structure of the present invention provides both interconnecting micro pores and macro pores to conduct both water vapor and oxygen to the roots of the plants growing in the medium, and maintains this pore structure over a period of time, unlike prior art materials in which the pores collapse with use. The basis for maintaining such a structure is dependent upon the use of modern binders, particularly diphenylmethane diisocyanate (MDI), which, with combined with the other elements of the invention, produces a polyurethane sponge. MDI has the advantage of not containing chemicals harmful to human life, in contrast to other prior-art binders which produce polyurethane sponges.

The growing media of the present invention provides a unique environment for plant growth. It offers a robust physical substrate, containing all of the nutrients required for healthy plants, beginning with proper root development. It provides high aeration by means of the macro pores contained throughout the structure, as well as good water retention provided by the micro pores throughout, all of which pores remain within the structure during its lifetime. The high cation exchange capacity required for plant growth is provided for by the incorporation of composted bark. Time-release fertilizer further is included to feed the plants. And finally, fungicides and insecticides keep the plants from being attacked. The invention provides the perfect balance of air, water, and nutrients for growing a wide variety of plants.

The advantages of the growth medium of the present invention may be summarized as follows:
a) Holds 50% more water than traditional soils;
b) Eliminates pot-bound roots;
c) Promotes expansive root growth;
d) Since moisture and air are regulated for ideal growing conditions, plants cannot be over watered;
e) Reduces watering, thereby promoting healthier plants
f) Water migrates or wicks from the areas of higher moisture content to those of lower moisture content;
g) Absorbs the correct amount of water, allowing oxygen access to the plant roots; and
h) Insulates the roots, protecting them during dry conditions.

### SUMMARY OF THE INVENTION

It is an object of this invention to provide a structured substrate growing medium which combines water retention, nutrients, beneficial bacteria, and a robust physical structure containing both micro pores and macro pores.

In accordance with a first aspect of the invention, the growing medium contains sea solids containing trace elements, actino iron (a chemical alternative for use against root rot diseases), controlled-release fertilizer, composted bark, peat, and MDI.

In accordance with a second aspect of the invention the components are mixed and formed into polyurethane foam having interconnecting micro and macro pores.

In accordance with a third aspect of the invention the foam is molded into forms.

In accordance with a fourth aspect of the invention the material also contains a time-release fertilizer.

In accordance with a fifth aspect of the invention, the sea solid has a minimum concentration of 5 lbs per cubic yard, the beneficial bacteria have a minimum concentration of 0.25 lbs per cubic yard, and the controlled-release fertilizer has a minimum concentration of 1 lb per cubic yard.

In accordance with a sixth aspect of the invention, the hydrophilic polymer comprises between 8% and 10% of the medium substrate by volume.

In accordance with a seventh aspect of the invention, the carbon-based fibrous material comprises between 81% and 83% of the medium substrate by volume.

In accordance with an eighth aspect of the invention, the composted bark comprises between 7% and 9% of the medium substrate by volume.

In accordance with a ninth aspect of the invention, the carbon-based fibrous material comprises between 85% and 90% of the medium substrate by volume.

In accordance with a tenth aspect of the invention the composted bark comprises between 5% and 9% by volume.

In accordance with an eleventh aspect of the invention the hydrophilic polymer further comprises MDI.

### DESCRIPTION OF PREFERRED EMBODIMENTS

The present invention has many applications. The present invention has many innovative applications in horticulture as follows: Green roofs (environmental and waste water); “rooting tray” or “sheet buns”; “Plug and play”; “loose growing media” (both indoors and outdoors); “living walls”; “Floating Islands”; Habitat Restoration and enhancements; Commercial Growers; and Sod market.

The growth medium of the present invention is hydroponic. It prevents plant stress, because it retains water and proper nutrients without the possibility of over or under watering. The medium thus protects and insulates the roots.

The present invention is particularly appropriate for these applications because of the improved structural stability of the presently described growing medium, both in improved wet strength, tensile strength, and tear resistance, as well as the ability to maintain the interconnecting pore structure.

Composition of the Growing Medium

The growing medium is composed of the following essential elements in the proper proportions:
(a) composted bark
(b) a carbon-based fibrous material
(c) a hydrophilic polymer
(d) sea solids, typified by sea salt
(e) beneficial bacteria

Each of these is discussed in the following description.

Beneficial Bacteria/Biological Fungicides

These additives are used to control soil-carried root rot and fungi. In the preferred embodiment a commercial product called Actino-iron®, Manufactured by Natural Industries, Inc., of Houston, Tex., is used. Actino-iron contains biological grade iron and humate. It also contains the patented micro-organism Streptomyces lydicus which colonizes plant roots and protects them from rot. In the process the roots are actually encapsulated, so that fungus cannot reach the root surface. The fungicides contained by this material actively attack certain types of fungi. The incorporation of this fungicide into the present invention provides a further benefit to the growing medium, allowing for hardier and larger root development, and healthier plants as a result.

In the present invention, the Actino-iron is used in minimum concentrations of 4 lb. per cubic yard.

Sea Solids

Sea solids, which are typified by sea salt, may be used to provide a variety of chemical elements, some in trace quantities, which have been shown to be beneficial to plant growth. Particular Sea solids, such as salt from the Dead Sea in Israel, have been analyzed and found to contain almost all of the mineral elements, and in the same concentration, as in human blood. In the present embodiment sea solid is added in a concentration of about 0.25 lbs per cubic yard, as a minimum.

Carbon-Based Fibrous Material

In the preferred embodiment of the present invention, peat is the chosen carbon-based fibrous material, which is the major component of the present invention in terms of volume. In the preferred embodiment peat makes up 85% to 90% of the medium substrate by volume, of the horticultural growth material. It is one of many carbon-based fibers which can serve the purpose of providing the bulk of the material, giving it structure. Other candidates include coir (coconut fiber), compost from waste plants, cellulose, and ash.

Composted Bark

This component makes up between 7% and 9% of the volume of the horticultural growing material in the preferred embodiment. It provides a high level of cation exchange which is needed for root growth. It is widely known in the prior art that cation exchange is essential for the retaining of nutrients, and is included in the present invention for that purpose.

Hydrophilic Polymer

The physical structure of the present invention is generally a substrate in the form of a hydrophilic polymeric sponge containing inter-connecting pores which make the other elements of the material available to the roots of the plants growing therein.

The above structure is created by the use of a material which, in the preferred embodiment of the present invention, is the polyurethane known as diphenylmethane diisocyanate (MDI). This material makes up between 5% and 20%, by volume, of the material.

The resulting substrate has several qualities essential to the present invention. First, it contains no components which are known to be harmful to humans and other living things, in contrast to other hydrophilic polymers, especially isocyanates, such as Toluene diisocyanate (TDI), which was formerly used in applications similar to the present invention.

Secondly, the use of MDI produces a stable pore structure with pore size which can range from microcellular to fully reticulated. Typical pore size will be between 0.2 mm and 4.0 mm.

The Manufacturing Process

The present invention uses a manufacturing process which is well known in the prior art. The soluble components are dissolved in water, and the solution is then combined with the non-soluble components, including the peat moss and the composted bark. A binder, such as Hypol®, sold by Dow Chemical, helps to insure that pore structure is proper, which is essential for proper root growth.

### EXAMPLE 1

The horticultural growing medium contains a minimum of ¼ lbs per cubic yard of sea solid, a minimum of 5 lbs per cubic yard of actino iron, a minimum of 1 lb per cubic yard of controlled-release fertilizer, 5-9% by volume of composted bark, 85-90% peat, and 5-20% of MDI. The components are mixed and formed into polyurethane foam having interconnecting micro and macro pores, and the foam is molded into forms.

### EXAMPLE 2

The horticultural growing medium contains a minimum of 0.25 lbs per cubic yard of sea solid, a minimum of 5 lbs per cubic yard of actino iron, a minimum of 1 lb per cubic yard of controlled-release fertilizer, 7-9% by volume of composted bark, 81-83% peat, and 8-10% of MDI. The components are mixed and formed into polyurethane foam having interconnecting micro and macro pores, and the foam is molded into forms.

While the invention has been described with reference to specific embodiments, it will be apparent that improvements and modifications may be made within the purview of the invention without departing from the scope of the invention defined in the appended claims.

1. A horticultural growing medium, comprising:
a) composted bark;
b) a carbon-based fibrous material;
c) a hydrophilic polymer;
d) sea solid; and
bacteria that colonizes plant roots and encapsulates them, protects them from rot,
formed into a solid structured polyurethane-sponge-like substrate medium, having structural stability, and which contains interconnecting micro and macro pores.

2. The horticultural growing medium in accordance with claim 1 further comprising a controlled release fertilizer.

3. The horticultural growing medium of claim 26, wherein:
(b) the bacteria have a minimum concentration of 5 lbs per cubic yard;
(c) the sea solid has a minimum concentration of ¼ lbs per cubic yard;
(d) the controlled-release fertilizer has a minimum concentration of 1 lb. per cubic yard.

4. The horticultural growing medium of claim 3, wherein the hydrophilic polymer comprises between 8% and 10% of the medium substrate by volume before mixing with the other ingredients.

5. The horticultural growing medium of claim 4, wherein the carbon-based fibrous material comprises between 81% and 83% of the medium substrate by volume.

6. The horticultural growing medium of claim 5, wherein the composted bark comprises between 7% and 9% of the medium substrate by volume.

7. The horticultural growing medium of claim 4, wherein the carbon-based fibrous material comprises between 85% and 90% of the medium substrate by volume.

8. The horticultural growing medium of claim 7, wherein the composted bark comprises between 7% and 9% of the medium substrate by volume.

9. (canceled)

10. A green wall, consisting of one or more integrated substrates of horticultural growing medium in accordance with claim 9, wherein the green wall requires a minimum of watering, feeding, or other maintenance, and which can be installed in place without the use of containment structures, additional waterproofing, or drainage systems.

11. A green roof, consisting of one or more integrated substrates of horticultural growing medium in accordance with claim 22, wherein the green roof requires a minimum of watering, feeding, or other maintenance, and
which can be installed in place without the use of containment structures, additional waterproofing, or drainage systems.

12. An additive for enhancing soil for use in horticultural applications, the additive comprising a growth medium in accordance with claim 22 which is further ground into pieces and is intended for mixing with soil in a container intended for the growth of plants.

13. A container for the growth of plants, comprising the horticultural growing medium in accordance with claim 22 which has been molded into the form of a flower pot, window box, flat or similar container used for plant growth.

14. (canceled)

15. (canceled)

16. (canceled)

17. (canceled)

18. (canceled)

19. (canceled)

20. (canceled)

21. (canceled)

22. The growing medium of claim 2, wherein the hydrophilic polymer comprises MDI.

23. The growing medium of claim 22, wherein the bacteria comprises a member of the genus Streptomyces.

24. The growing medium of claim 23, wherein the bacteria comprises Streptomyces lydicus.

25. The growing medium of claim 24, further comprising actino acid.

26. The growing medium of claim 25, further comprising Actino-iron®
